(19) United States
(12) Patent Application Publication
(10) Pub. No.: US 2020/0301812 A1
(43) Pub. Date: Sep. 24, 2020

(54) EMULATING NON-TRACED CODE WITH A RECORDED EXECUTION OF TRACED CODE

(71) Applicant: Microsoft Technology Licensing, LLC, Redmond, WA (US)

(72) Inventor: Jordi MOLA, Bellevue, WA (US)

(21) Appl. No.: 16/358,221

(22) Filed: Mar. 19, 2019

(51) Int. Cl. G06F 11/36

(52) U.S. Cl. CPC G06F 11/364; G06F 11/3624; G06F 11/3664; G06F 11/3612

(57) ABSTRACT

The present disclosure relates to emulating non-traced code with a recorded execution of traced code. For example, embodiments access a replayable recorded execution of a prior execution of first executable code. The replayable recorded execution includes one or more inputs that were consumed by one or more first executable instructions during the prior execution of the first executable code. Second executable code, which is different from the first executable code, is also accessed. Execution of second executable code not is recorded in the replayable recorded execution. Execution of the second executable code is emulated using the one or more inputs from the replayable recorded execution. Embodiments might report differences between the emulated execution of the second executable code and the prior execution of the first executable code may be reported, or equivalency between the emulated execution of the second executable code and the prior execution of the first executable code.

### BACKGROUND

Tracking down and correcting undesired software behaviors is a core activity in software development. Undesired software behaviors can include many things, such as execution crashes, runtime exceptions, slow execution performance, incorrect data results, data corruption, and the like. Undesired software behaviors might be triggered by a vast variety of factors such as data inputs, user inputs, race conditions (e.g., when accessing shared resources), etc. Given the variety of triggers, undesired software behaviors can be rare and seemingly random, and extremely difficult reproduce. As such, it can be very time-consuming and difficult for a developer to identify a given undesired software behavior. Once an undesired software behavior has been identified, it can again be time-consuming and difficult to determine its root cause(s).

Developers have classically used a variety of approaches to identify undesired software behaviors, and to then identify the location(s) in an application's code that cause the undesired software behavior. For example, a developer might test different portions of an application's code against different inputs (e.g., unit testing). As another example, a developer might reason about execution of an application's code in a debugger (e.g., by setting breakpoints/watchpoints, by stepping through lines of code, etc. as the code executes). As another example, a developer might observe code execution behaviors (e.g., timing, coverage) in a profiler. As another example, a developer might insert diagnostic code (e.g., trace statements) into the application's code.

While conventional diagnostic tools (e.g., debuggers, profilers, etc.) have operated on “live” forward-executing code, an emerging form of diagnostic tools enable “historic” debugging (also referred to as “time travel” or “reverse” debugging), in which the execution of at least a portion of a program's thread(s) is recorded into one or more trace files (i.e., a recorded execution). Using some tracing techniques, a recorded execution can contain “bit-accurate” historic trace data, which enables the recorded portion(s) the traced thread(s) to be virtually “replayed,” down to the granularity of individual instructions (e.g., machine code instructions, intermediate language code instructions, etc.). Thus, using “bit-accurate” trace data, diagnostic tools can enable developers to reason about a recorded prior execution of subject code, as opposed to a “live” forward execution of that code. For example, a historic debugger might enable both forward and reverse breakpoints/watchpoints, might enable code to be stepped through both forwards and backwards, etc. A historic profiler, on the other hand, might be able to derive code execution behaviors (e.g., timing, coverage) from prior-executed code.

### BRIEF SUMMARY

At least some embodiments described herein leverage historic debugging technologies to emulate execution of non-traced code based on trace data from a recorded execution of related traced code. In other words, embodiments can use a recorded execution of first code to guide emulation of second code that was not traced into this recorded execution. In embodiments, the first and second code have differences, but are functionally related. For example, they may be compiled from the same source code using different compilers and/or different compiler settings, or may be compiled from different versions of the same source code project. As will be explained herein, emulating non-traced code with a recorded execution of related traced code can be useful for many useful purposes, such as to identify compiler bugs (e.g., when different compiler flags, compiler versions, or compiler products result in the production of functionally distinct binaries from the same source code), to determine if source code changes address undesired software behaviors and/or introduce new undesired software behaviors, or to enable debugging of non-optimized code based on a trace of optimized code.

In some embodiments methods, systems, and computer program products emulate execution of second executable code using trace data gathered during execution of first executable code. In particular, a replayable recorded execution of a prior execution of first executable code is accessed. The replayable recorded execution includes one or more inputs that were consumed by one or more first executable instructions during the prior execution of the first executable code. Second executable code, which is different than the first executable code, is also accessed. Execution of second executable code is not recorded in the replayable recorded execution. Execution of the second executable code is emulated using the one or more inputs from the replayable recorded execution. Embodiments could report one or more differences between the emulated execution of the second executable code and the prior execution of the first executable code, or equivalency between the emulated execution of the second executable code and the prior execution of the first executable code.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates an example computing environment that facilitates emulating non-traced code with a recorded execution of related traced code;

FIG. 1B illustrates an example debugging component;

FIG. 2 illustrates an example computing environment in which the computer system of FIG. 1A is connected to one or more other computer systems over one or more networks;

FIG. 3 illustrates an example of a recorded execution;

FIG. 4 illustrates an example of mappings between corresponding functions in the code of two applications, in which the functions are identified based on their inputs and outputs; and

FIG. 5 illustrates a flowchart of an example method for emulating execution of second executable code using trace data gathered during execution of first executable code.

### DETAILED DESCRIPTION

At least some embodiments described herein leverage historic debugging technologies to emulate execution of non-traced code based on trace data from a recorded execution of related traced code. In other words, embodiments can use a recorded execution of first code to guide emulation of second code that was not traced into this recorded execution. In embodiments, the first and second code have differences, but are functionally related. For example, they may be compiled from the same source code using different compilers and/or different compiler settings, or may be compiled from different versions of the same source code project. As will be explained herein, emulating non-traced code with a recorded execution of related traced code can be useful for many useful purposes, such as to identify compiler bugs (e.g., when different compiler flags, compiler versions, or compiler products result in the production of functionally distinct binaries from the same source code), to determine if source code changes address undesired software behaviors and/or introduce new undesired software behaviors, or to enable debugging of non-optimized code based on a trace of optimized code.

As indicated, the embodiments herein operate on recorded executions of executable entities. In this description, and in the following claims, a “recorded execution,” can refer to any data that stores a record of a prior execution of code instruction(s), or that can be used to at least partially reconstruct the prior execution of the prior-executed code instruction(s). In general, these code instructions are part of an executable entity, and execute on physical or virtual processor(s) as threads and/or processes (e.g., as machine code instructions), or execute in a managed runtime (e.g., as intermediate language code instructions).

A recorded execution used by the embodiments herein might be generated by a variety of historic debugging technologies. In general, historic debugging technologies record or reconstruct the execution state of an entity at various times, in order to enable execution of that entity to be at least partially emulated later from that execution state. The fidelity of that virtual execution varies depending on what recorded execution state is available.

For example, one class of historic debugging technologies, referred to herein as time-travel debugging, continuously records a bit-accurate trace of an entity's execution. This bit-accurate trace can then be used later to faithfully replay that entity's prior execution down to the fidelity of individual code instructions. For example, a bit-accurate trace might record information sufficient to reproduce initial processor state for at least one point in a thread's prior execution (e.g., by recording a snapshot of processor registers), along with the data values that were read by the thread's instructions as they executed after that point in time (e.g., the memory reads). This bit-accurate trace can then be used to replay execution of the thread's code instructions (starting with the initial processor state) based on supplying the instructions with the recorded reads.

Another class of historic debugging technology, referred to herein as branch trace debugging, relies on reconstructing at least part of an entity's execution state based on working backwards from a dump or snapshot (e.g., a crash dump of a thread) that includes a processor branch trace (i.e., which includes a record of whether or not branches were taken). These technologies start with values (e.g., memory and register) from this dump or snapshot and, using the branch trace to at least partially determine code execution flow, iteratively replay the entity's code instructions and backwards and forwards in order to reconstruct intermediary data values (e.g., register and memory) used by this code until those values reach a steady state. These techniques may be limited in how far back they can reconstruct data values, and how many data values can be reconstructed. Nonetheless, the reconstructed historical execution data can be used for historic debugging.

Yet another class of historic debugging technology, referred to herein as replay and snapshot debugging, periodically records full snapshots of an entity's memory space and processor registers while it executes. If the entity relies on data from sources other than the entity's own memory, or from a non-deterministic source, these technologies might also record such data along with the snapshots. These technologies then use the data in the snapshots to replay the execution of the entity's code between snapshots.

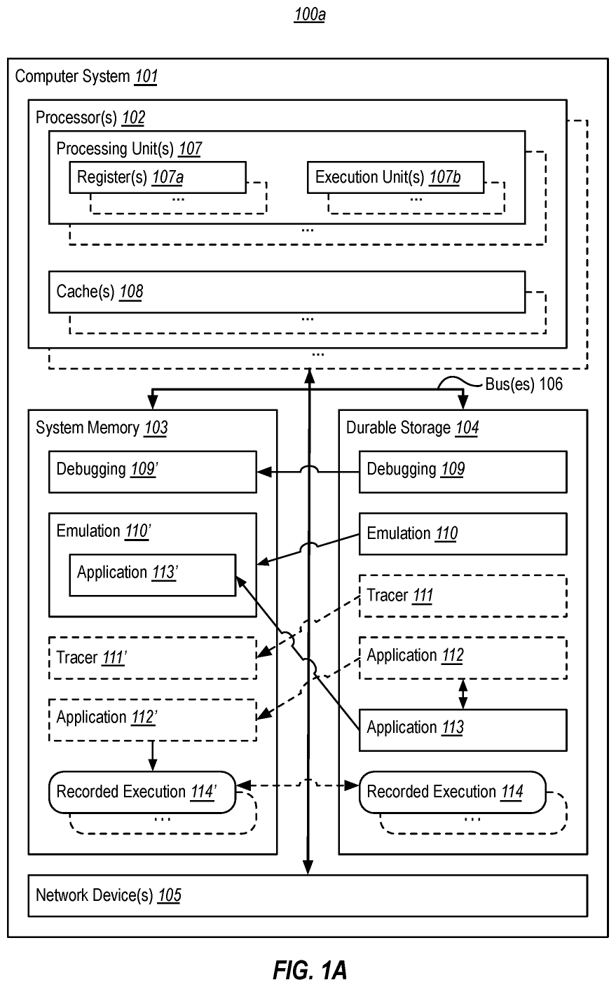

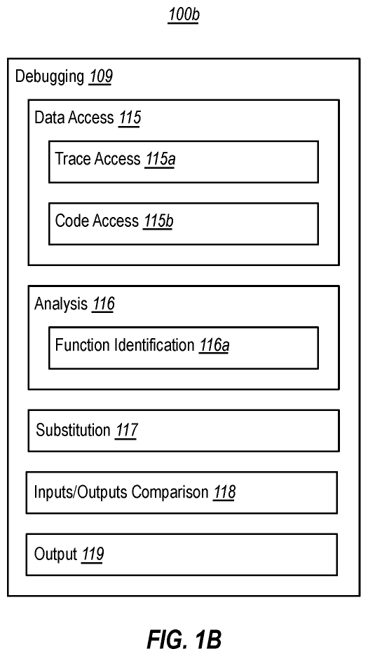

FIG. 1A illustrates an example computing environment 100a that facilitates emulating non-traced code with a recorded execution of related traced code. As depicted, computing environment 100a may comprise or utilize a special-purpose or general-purpose computer system 101, which includes computer hardware, such as, for example, one or more processors 102, system memory 103, durable storage 104, and/or network device(s) 105, which are communicatively coupled using one or more communications buses 106.

Embodiments within the scope of the present invention can include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media (e.g., system memory 103 and/or durable storage 104) that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., network device(s) 105), and then eventually transferred to computer system RAM (e.g., system memory 103) and/or to less volatile computer storage media (e.g., durable storage 104) at the computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, machine code instructions (e.g., binaries), intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“laaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

As shown in FIG. 1A, each processor 102 can include (among other things) one or more processing units 107 (e.g., processor cores) and one or more caches 108. Each processing unit 107 loads and executes machine code instructions via the caches 108. During execution of these machine code instructions at one more execution units 107b, the instructions can use internal processor registers 107a as temporary storage locations, and can read and write to various locations in system memory 103 via the caches 108. In general, the caches 108 temporarily cache portions of system memory 103; for example, caches 108 might include a “code” portion that caches portions of system memory 103 storing application code, and a “data” portion that caches portions of system memory 103 storing application runtime data. If a processing unit 107 requires data (e.g., code or application runtime data) not already stored in the caches 108, then the processing unit 107 can initiate a “cache miss,” causing the needed data to be fetched from system memory 103—while potentially “evicting” some other data from the caches 108 back to system memory 103.

As illustrated, the durable storage 104 can store computer-executable instructions and/or data structures representing executable software components; correspondingly, during execution of this software at the processor(s) 102, one or more portions of these computer-executable instructions and/or data structures can be loaded into system memory 103. For example, the durable storage 104 is shown as storing computer-executable instructions and/or data structures corresponding to a debugging component 109, an emulation component 110, and an application 113, as well as one or more recorded executions 114 (e.g., generated using one or more of the historic debugging technologies described above).

In general, the debugging component 109 leverages the emulation component 110 in order to emulate execution of code of application 113 based on execution state data obtained from one or more of the recorded executions 114. Thus, FIG. 1A shows that the debugging component 109 and the emulation component 110 are loaded into system memory 103 (i.e., debugging component 109′ and emulation component 110′), and that the application 113 being emulated within the emulation component 110′ (i.e., application 113′).

The durable storage 104 and system memory 103 are also shown as potentially storing computer-executable instructions and/or data corresponding to a tracer component 111 and an application 112. These components are shown in broken lines because they may exist at some other computer system rather than computer system 101 (though they could also exist at the other computer system(s) in addition to computer system 101). In general, the tracer component 111 records or traces prior execution(s) of application 112 into the recorded execution(s) 114 (e.g., using one or more types of the historic debugging technologies described above). For example, if computer system 101 includes the tracer component 111 and the application 112, these components can be loaded into system memory 103 (i.e., tracer component 111′ and application 112′); then, as indicated by the arrow between application 112′ and recorded execution 114′, the tracer component 111′ can record execution of application 112′ at the processor(s) 102 into recorded execution 114′ (which might then be persisted to the durable storage 104 as recorded execution 114).

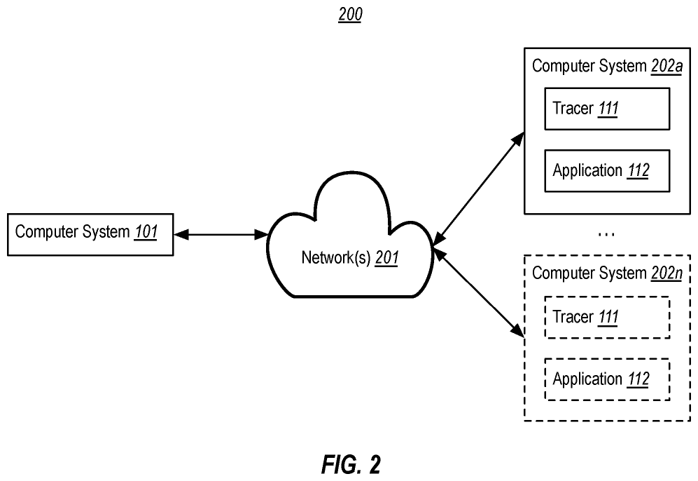

Alternatively, computer system 101 could receive one or more of the recorded executions 114 from another computer system (e.g., using network device(s) 105). For example, FIG. 2 illustrates an example computing environment 200 in which computer system 101 of FIG. 1A is connected to one or more other computer systems 202 (i.e., 202a-202n) over one or more networks 201. As shown, in example 200 each computer system 202 includes a tracer component 111 and a copy of application 112. As such, computer system 101 may receive one or more recorded execution(s) 114 of application 112 from these computer system(s) 202 over the network(s) 201.

Returning to FIG. 1A, as indicated by the arrow between application 112 and 113, these applications can be functionally related. For example, application 112 and 113 might be functionally related because they were compiled from identical source code, but with different compiler settings. For instance, application 112 might be a build that has one or more compiler optimization flags enabled (e.g., a “production build”), while application 113 might be a build that has these compiler optimization flag(s) disabled (e.g., a “debug” build). Additionally, or alternatively, application 112 might be compiled with one version of a compiler, while application 113 is compiled with another version of the compiler. Additionally, or alternatively, application 112 and application 113 might compiled with different compiler products altogether. As another example, application 112 and 113 might be functionally related because they were compiled from different versions of the same code. For instance, application 112 might be built from one version of source code, while application 113 is built from a more recent version of the source code that includes fixes, such as bug fixes and/or performance improvements.

It is noted that, while the debugging component 109, the emulation component 110, and/or the tracer component 111 might each be independent components or applications, they might alternatively be integrated into the same application (such as a debugging suite), or might be integrated into another software component—such as an operating system component, a hypervisor, a cloud fabric, etc. As such, those skilled in the art will also appreciate that the invention may be practiced in a cloud computing environment of which computer system 101 is a part.

It was mentioned previously that the debugging component 109 leverages the emulation component 110 in order to emulate execution of code of application 113 using execution state data from one or more of the recorded executions 114. However, as also discussed, in embodiments recorded executions 114 may correspond to a prior execution of application 112 (rather than application 113). As such, in accordance with the embodiments herein, the debugging component 109 can use execution state data relating to a prior execution of application 112 in order to guide emulation of executable code corresponding to application 113 (rather than application 112). Thus, the debugging component 109 can effectively use the emulation component 110 to guide emulation of non-traced code (i.e., application 113) based on a recorded execution (i.e., recorded execution 114) of related traced code (i.e., application 112).

As will be appreciated in view of the disclosure herein, emulating non-traced code with a recorded execution of related traced code can be useful for many debugging purposes. For example, it can be used to detect/identify bugs or differences in compilers. For instance, if application 112 and application 113 were both compiled from the same source code, but with different compiler products, different compiler settings, and/or different compiler versions, application 112 and application 113 should both exhibit equivalent behaviors during their execution. However, if emulation of application 113 based on recorded executions 114 produces different results than application 112 produced during its recorded execution, there is evidence of compiler bugs (or, at least, functional differences between compiler products or versions).

In another example, emulating non-traced code with a recorded execution of related traced code can be useful to test source code changes that should make only performance improvements. For instance, if application 113 is compiled from a version of source code that includes only performance improvements as compared to a version of source code from which application 112 was compiled, then application 113 should exhibit equivalent behaviors as application 112 when it is being emulated using trace data gathered during execution of application 112; if there is a difference, then the performance improvements caused behavioral changes that may have introduced bug(s)/regression(s).

In another example, emulating non-traced code with a recorded execution of related traced code can be useful to test source code changes that should make only bug fixes. For instance, suppose that recorded executions 114 include ten recorded executions of application 112, two of which exhibit some undesired behavior (e.g., bug). If application 113 was compiled from a version of source code that includes a fix for this bug, then application 113 should not exhibit the undesired behavior when being emulated using the two recorded executions during which application 112 exhibited the undesired behavior; otherwise, the bug was probably not fixed. Additionally, application 113 should exhibit equivalent behaviors as application 112 when it is being emulated using the other eight recorded executions; otherwise, the bug fix probably introduced new bug(s)/regression(s).

In another example, emulating non-traced code with a recorded execution 114 of related traced code can be used to debug the recorded execution 114 using non-optimized code, based on trace data that was captured during execution of optimized code. As will be appreciated by those of skill in that art, it can be difficult for a human user to reason about execution of code that was compiled with compiler optimizations enabled. For instance, when visualizing execution of optimized code in a debugger, the executed code flow may not appear to correspond to the expected code flow of the source code that the human user interacts with. Thus, for example, application 112 may be a compiler-optimized “production” build that is in active use, with its execution being traced into recorded execution 114. Because application 112 comprises optimized code, it may be difficult for a human user to reason about the execution behaviors that are traced into recorded execution 114 (e.g., if the debugging component 109 caused application 112 to be emulated using recorded execution 114). However, embodiments might use trace data in this recorded execution 114 to emulate execution of application 113, which might be a “debug” build that was compiled without optimizations settings enabled—making it much easier for a human user to reason about the execution behaviors that are traced into recorded execution 114.

To demonstrate how the debugging component 109 might accomplish emulation of non-traced code (e.g., application 113) with a recorded execution of related traced code (e.g., application 112), FIG. 1B illustrates an example 100b that provides additional detail of the debugging component 109 of FIG. 1A. The depicted debugging component 109 includes a variety of components (e.g., data access 115, analysis 116, substitution 117, inputs/outputs comparison 118, output 119, etc.) that represent various functionality the debugging component 109 might implement in accordance with various embodiments described herein. It will be appreciated that the depicted components—including their identity, sub-components, and arrangement—are presented merely as an aid in describing various embodiments of the debugging component 109 described herein, and that these components are non-limiting to how software and/or hardware might implement various embodiments of the debugging component 109 described herein, or of the particular functionality thereof.

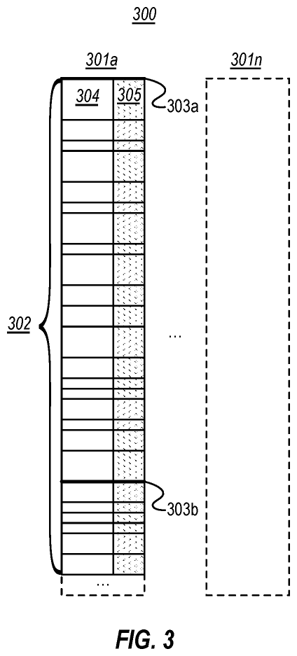

The data access component 115 includes a trace access sub-component 115a and a code access sub-component 115b. The trace access sub-component 115a accesses recorded executions, such a recorded execution 114 of a prior execution of application 112. FIG. 3 illustrates one example of a recorded execution 300 that might be accessed by the trace access sub-component 115a, where the recorded execution 300 might have been generated using time-travel debugging technology.

In the example of FIG. 3, recorded execution 300 includes a plurality of data streams 301 (i.e., 301a-301n). In embodiments, each data stream 301 records execution of a different thread that executed from the code of application 112. For example, data stream 301a might record execution of a first thread of application 112, while data stream 301n records an nth thread of application 112. As shown, data stream 301a comprises a plurality of data packets 302. Since the particular data logged in each data packet 302 might vary, they are shown as having varying sizes. In general, when using time-travel debugging technologies, each data packet 302 records at least the inputs (e.g., register values, memory values, etc.) to one or more executable instructions that executed as part of this first thread of application 112. As shown, data stream 301a might also include one or more key frames 303 (e.g., 303a, 303b) that each records sufficient information, such as a snapshot of register and/or memory values, that enables the prior execution of the thread to be replayed by the emulation component 110 starting at the point of the key frame forwards.

In embodiments, a recorded execution 114 might include the actual code that was executed. Thus, in FIG. 3, each data packet 302 is shown as including a non-shaded data inputs portion 304 and a shaded code portion 305. In embodiments, the code portion 305 of each data packet 302 might include the executable instructions that executed based on the corresponding data inputs. In other embodiments, however, a recorded execution 114 might omit the actual code that was executed, instead relying on having separate access to the code of application 112 (e.g., from durable storage 104). In these other embodiments, each data packet may, for example, specify an address or offset to the appropriate executable instruction(s).

Returning to FIG. 1B, the code access sub-component 115b of the data access component 115 obtains the code of both application 112 and application 113. If the recorded execution 114 that was obtained by the trace access sub-component 115a included the code of application 112 (e.g., code portion 305), then the code access sub-component 115b might extract the code of application 112 from the recorded execution 114. Alternatively, the code access sub-component 115b might obtain the code of application 112 from the durable storage 104. In either case, the code access sub-component 115b can obtain the code of application 113 from the durable storage 104.

Based on the code accessed by the code access sub-component 115b, the analysis component 116 identifies mappings between different code sections in applications 112 and 113, which mappings are usable to emulate the code of application 113 using the execution state data recorded in recorded execution 114 during execution of application 112 (e.g., the data inputs portions 304 of data packets 302). As shown, for example, the analysis component 116 includes a function identification sub-component 116a. The function identification sub-component 116a identifies mappings between corresponding “functions” in the code of applications 112 and 113, based on identifying inputs and outputs to those functions.

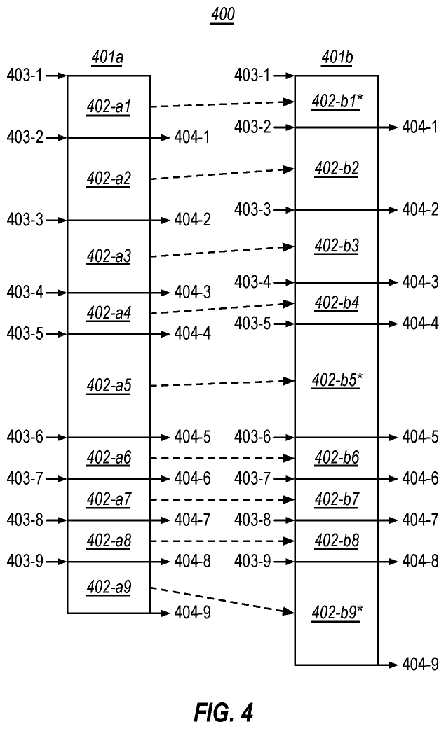

For example, FIG. 4 illustrates an example 400 of mappings between corresponding “functions” in the code of applications 112 and 113, in which the functions are identified based on their inputs and outputs. In particular, FIG. 4 shows a representation 401a of code of application 112, as well as a representation 401b of code of application 113. FIG. 4 also shows that there is correspondence between different chunks of code (functions) in the two representations 401. For example, function 402-a1 in representation 401a corresponds to function 402-b1 in representation 401b, function 402-a2 in representation 401a corresponds to function 402-b2 in representation 401b, and so on. Notably, while, for clarity, there is a linear correspondence between identified functions, this need not be the case. For instance, in an alternative mapping it might be that function 402-a9 corresponds to function 402-b1 and that function 402-a1 corresponds to function 402-b9, such that an arrow between functions 402-a9 and 402-b1 would cross an arrow between functions 402-a1 and 402-b9.

As used herein, a “function” is defined as a collection of one or more sections of execution, each section comprising a chunk of one or more executable instructions that has zero or more “inputs” and one or more “outputs.” A function in the code of application 112 can map to a corresponding function in the code of application 113 if these functions both read from the same input(s) and write to the same output(s), even if the code in those functions is not identical. For example, in FIG. 4, each function 402 has a corresponding set of input(s) 403 and a corresponding set of output(s) 404. Function 402-a1 in application 112, for instance, has a set of input(s) 403-1 and a set of outputs 404-1, function 402-a2 in application 112 has a set of input(s) 403-2 and a set of outputs 404-2, etc. As shown, corresponding functions between applications 112 and 113 have the same sets of inputs and outputs. For example, function 402-b1 in application 113 has the same sets of inputs and outputs (i.e., inputs 403-1 and outputs 404-1) as function 402-a1 in application 112, function 402-b2 in application 113 has the same sets of inputs and outputs (i.e., inputs 403-2 and outputs 404-2) as function 402-a2 in application 112, etc. Generally, the function identification sub-component 116a attempts to map functions that are closely related in behavior.

As used herein, an “input” is defined as any data location from which a function (as defined above) reads, and to which the function itself has not written prior to the read. These data locations could include, for example, registers as they existed the time the function was entered, and/or any memory location from which the function reads and which it did not itself allocate. An edge case may arise if a function allocates memory and then reads from that memory prior to initializing it. In these instances, embodiments might either treat the read to uninitialized memory as an input, or as a bug. As used herein, an “output” is defined as any data location (e.g., register and/or memory location) to which the function writes that it does not later deallocate. For example, a stack allocation at function entry, followed by a write to the allocated area, followed by a stack deallocation at function exit, would not be considered a function output.

In embodiments, the function identification component 116a might rely a known application binary interface (ABI) of the operating system and processor instruction set architecture (ISA) for which application(s) 112/113 are compiled in order to know which register(s) are input(s) to a function and/or which register(s) are output(s) from a function—reducing the need to track registers individually. Thus, for instance, instead of tracking registers individually, the function identification component 116a might use an ABI for which application(s) 112/113 were compiled to determine which register(s) the application(s) 112/113 use to pass parameters to functions, and/or which register(s) the application(s) 112/113 use for return values. In embodiments, debugging symbols might be used to complement, or replace ABI information. Notably, even if calling function ignores the return value of a called function, an ABI and/or symbols may still be usable to determine if the contents of a register used to store the called function's return value have changed.

As mentioned, a given function might be a collection of one or more sections of one or more executable instructions. At times, it might take a plurality of sections in order to identify functions that cleanly map from one application to another. For example, it may by that a particular section might be identifiable in one application (e.g., application 112) that does not cleanly map to the other application (e.g., application 113). As such, this section, itself, would be a poor choice for a “function” that maps between applications (i.e., having the same inputs and outputs, and doing equivalent work). Even if compiled from identical source code, such differences could arise due to compiler optimization settings, in which code in application 113 is transformed by a compiler in a way that does not directly map to application 112. For instance, while a distinct section of code (with defined sets of inputs and outputs) may be identifiable in application 112 (e.g., non-optimized code), it might be optimized away entirely in application 113 (e.g., optimized code). Alternatively, while a first section of code in application 112 might have a common sets of inputs and outputs with a second section of code in application 113, the first section of code in application 112 might do some work that has been optimized out of the second section of code in application 113 and placed into a third section of code in application 113; for example, some work may have been lifted out of a loop. Thus, in order to facilitate clean function mappings between these two applications, a given “function” that is identified as mapping to another application might actually be a collection of a plurality of sections. For instance, in the examples above of a compiler optimizing code away entirely in application 113, or of a compiler moving work from the second chunk of code in application 113 to the third chunk of code in application 113, it might actually take combining two (or more) sections in one or both of applications 112 and 113 in order to arrive at common functions between applications 112 and 113 that have mappable sets of inputs and outputs, and that do equivalent work.

In embodiments, when defining a function as a collection of sections, this can be done inclusively, exclusively, or somewhere in-between. For example, suppose that the function identification sub-component 116a can identify three sections—A, B, and C—in application 112, in which section A called section B, and in which section B called section C during the traced execution. In this situation, a single “function” in application 112 (and that maps with application 113) might be defined as the sum of the chunks of code in sections A, B, and C (i.e., inclusive of everything section A called during the traced execution). Alternatively, a single “function” for mapping with application 113 might be defined as the chunk of code in section A only (i.e., exclusive of section function A called during the traced execution). Alternatively again, a single “function” for mapping with application 113 might be defined as the sum of the chunks of code in sections A and B, but not section C (i.e., partially inclusive and partially exclusive).

In embodiments, it is possible for the function identification component 116a to define and map functions that include sequences of instructions that have one or more gaps within their execution. For example, a function might include a sequence of instructions that make a kernel call—which is not recorded—in the middle of their execution. To illustrate, function 402-a1 might take as inputs a file handle and a character, and include instructions that compare each byte of the file with the input character to find occurrences of the character in the file. Because they rely on file data, these instructions might make one or more kernel calls to read the file (e.g., using the handle as a parameter to the kernel call). This function 402-a1 (with its gap(s)) might then be mapped to function 402-b1—which could be an alternate implementation/compilation of those instructions, with their own gap(s). In order to identify/map functions with gaps, the function identification component 116a may need to ensure that these gaps are properly ordered in each of functions 402-a1 and 402-b1 with respect to the comparison operations, so the file data is processed in the same order in each of functions 402-a1 and 402-b1. Since the sets of inputs 403-a and outputs 404-1 of functions 402-a1 and 402-b1 do not change, any differences would be internal to the functions, and these differences (e.g. different local data structures) are eventually deallocated (e.g., stack popping being a deallocation) so the differences don't affect the outputs of the functions. It is noted that, in embodiments, any register values changed by a kernel call are tracked in the recorded execution(s) 113. Nonetheless, the function identification component 115a might additionally, or alternatively, use an ABI and/or debugging symbols to track which registers values are retained across a kernel call. For instance, the stack pointer (i.e., ESP on x85 or R13 on ARM) is retained across kernel calls.

In embodiments, inputs and outputs are composable. For example, if a single function in application 112 is inclusively defined as the entirety of the code in sections A, B, and C, then this function's set of inputs might be defined as an input set including the combination of each of the inputs of sections A, B, And C, and its set of outputs might be defined as an output set including the combination of each of the outputs of sections A, B, and C. It will be appreciated that when an input (or output) to section B is allocated by (or de-allocated by) section A, or if it is allocated by section B and de-allocated by section A, then that input (or output) to section B may be omitted from the input set (or output set). It will also be appreciated that any input (or output) of a section called within a broader function (i.e., that includes the section), and which is not an input (or output) of the broader function may be omitted from an input set (or output set) for the broader function, or may otherwise be tracked as internal to the broader function.

Complications might also arise due to function inlining, particularly when a child function is not going to be analyzed by the debugging component 109 (e.g., because it comes from a third-party library). For instance, suppose that a first section (A1) of function A executes prior to calling child function B, and then a second section (A2) of function A executes after function B returns. Here, sections A1 and A2 might be treated as independent functions, themselves, with their own sets of inputs and outputs. If function B takes as inputs any of the outputs of A1, those outputs need to be produced before calling into function B; similarly, if function A2 takes as inputs any of the outputs of function B, then those outputs need to appear after the invocation of function B.

In the context of these definitions, if a given chunk of executable instructions that make up a function are deterministic, they should always produce the same data values in their outputs when given the same data values in their inputs. If this chunk of executable instructions is transformed in a way that is functionally equivalent (e.g., due to compiler optimizations, due to variances in compilers, and/or due to source code transformations that fix bugs or improve performance without altering behavior of the function as a whole), they should still produce these same output data values when given these same input data values.

For example, in FIG. 4, functions 402-b1, 402-b5, and 402-b9 in representation 401b of application 113 are shown with asterisks, indicating that the executable instructions in these functions have been transformed as compared to their corresponding functions (i.e., 402-a1, 402-a5, and 402-a9) in representation 401a of application 112. In embodiments, these transformations may be the result of application 113 being compiled with different compiler flags, or with a different compiler version or compiler type as compared with application 112, that resulted in different executable instructions being generated for functions 402-b1, 402-b5, and 402-b9 than functions 402-a1, 402-a5, and 402-a9. Additionally, or alternatively, in embodiments, these transformations may be the result of application 113 being compiled from modified source code that includes fixes or improvements that resulted in different executable instructions being generated for functions 402-b1, 402-b5, and 402-b9 than functions 402-a1, 402-a5, and 402-a9.

Notably, a chunk of executable instructions might include one or more individual instructions that are known to be non-deterministic. For instance, the x86 rtdsc instruction returns a time stamp counter (TSC), when called. Thus, each time the rtdsc instruction is called, it returns a different value that is not easily predicted prior to its call. In embodiments, the debugging component 109 is capable of identifying and dealing with some known non-deterministic instructions, thereby being able to consider two corresponding functions (e.g., functions 402-a1 and 402-b1) deterministic, even if they contain non-deterministic instructions. For instance, in addition to inputs to various instructions, a recorded execution 114 might also store the “side effects” (including outputs) of non-deterministic instructions. Thus, if a non-deterministic instruction appears the same number of times in corresponding functions (e.g., 402-a1 and 402-b1), the emulation component 110 might emulate these non-deterministic instructions returning the recorded side-effects. Alternatively, the emulation component 110 might produce a fictitious, but heuristically-valid value for the non-deterministic instruction. For instance, for the rtdsc instruction a heuristically-valid value could be a value that is greater than a value returned the last time the instruction was called in the recorded execution, but less than a value returned a next time the instruction was called in the recorded execution. Of course, the emulation component 110 could also refuse to perform an emulation of a non-deterministic instruction.

The debugging component 109 might also deal with complexities that could arise due to reads/writes to memory-mapped hardware registers. For instance, it may be that function 402-a1 accesses a register at one address via a hardware memory-mapped register in a first hardware environment, while function 402-b1 accesses the register at another address in a second hardware environment (e.g., because it is not memory-mapped to the first memory address in the second hardware environment). In embodiments, the emulation component 110 may recognize that the read in function 402-b1 corresponds to the read in function 402-a1, even though they are to different addresses, and uses a recorded execution 114 to return a recorded value that was read from the memory-mapped register by function 402-a1 when emulating the read from the non-memory-mapped register in function 402-b1.

Based on the functions 402 (including inputs 403 and outputs 404) identified by the analysis component 116, the substitution component 117 uses the emulation component 110 to “replay” recorded execution 114, while substituting the code of application 112 with the code of application 113. For example, suppose that recorded execution 114 includes execution state data relating to a prior execution of function 402-a1 during execution of application 112. Typically, to replay this prior execution of the executable instructions of function 402-a1, the emulation component 110 would use recorded data inputs (e.g., the data inputs portion 304 of data packets 302) to provide data values, as needed, to data locations corresponding to the inputs 403-1 that were consumed by the executable instructions of function 402-a1. The emulation component 110 would then emulate these instruction's execution using these data values, in order to produce data values in the data locations corresponding to outputs 404-1.

In embodiments, however, rather than using the executable instructions of function 402-a1, the substitution component 117 causes the emulation component 110 to use these same recorded data inputs to provide data values, as needed, during emulation of the executable instructions of function 402-b1. This process can be repeated for any of functions 402-b1 to 402-b9.

As noted, if the executable instructions of function 402-b1 are functionally equivalent to the executable instructions of function 402-a1, then emulation of the executable instructions of function 402-b1 using these recorded data inputs should produce the same data values in outputs 404-1 that were generated by function 402-a1. The inputs/outputs comparison component 118 can compare the outputs generated when emulating function 402-b1 to the outputs that were generated by function 402-a1 to determine whether or not this is the case. If the inputs/outputs comparison component 118 determines that the outputs are the same when receiving the same inputs, then the executable instructions of function 402-a2 do appear to be equivalent to the executable instructions of function 402-a1 (at least for these inputs). If the outputs are not the same when receiving the same inputs, then the executable instructions of function 402-a2 may definitely be determined to not be equivalent to the executable instructions of function 402-a1. In embodiments, the outputs function 402-a1 might be obtained from recorded execution 114, or might be obtained by also emulating the executable instructions of function 402-a1.

As was mentioned, a function might include gaps, such as a gap caused by call to a non-traced kernel call. In embodiments, the emulation component 116 can use one or more techniques to gracefully deal with these gaps. As a first example, the emulation component 116 might determine from an accessed recorded execution 113 what inputs were supplied to the kernel call, and then emulate the kernel call by the emulation component 116 based on those inputs. As a second example, the emulation component 116 might treat the kernel call as an event that can be ordered among other events in an accessed recorded execution 113, and rather than emulating the kernel call, the emulation component 116 can ensure that any visible changes made by the kernel call (e.g., changed memory values, changed register values, etc.) are exposed as inputs to code that executes after the kernel call. As a third example, the emulation component 116 might set up appropriate environmental context, and then make an actual call to a running kernel using these inputs. As a fourth example, emulation component might simply prompt a user for the results of a kernel call.

The output component 119 can output the results of having emulated the code of application 113 using input data values obtained from recorded execution 114 of execution of application 112. For example, the output component 119 might provide any results generated by the inputs/outputs comparison component 118, and/or might provide the results of emulation of the code of application 113 to a time-travel debugging component or user interface, enabling, for example, forward and reverse breakpoints on the code of application 113, rather than the code of application 112. If the output component 119 provides results generated by the inputs/outputs comparison component 118 it might report any differences between the outputs generated during emulation of application 113 and the outputs generated by application 112 during it recorded execution, or it might report that these outputs were identical.

In embodiments, the debugger 109 might be configured to validate, from the recorded execution(s) 114, whether application code (e.g., applications 112/113) actually followed one or more parameter annotations and/or contracts when it was executed and/or emulated. As used herein, the terms “parameter annotations” and “contracts” refer to specific code annotations that define how a code element or section should behave. For instance, code annotations could specify preconditions (e.g., requirements that must be met when entering a method or property), postconditions (e.g., expectations at the time a method or property code exits), object invariants (e.g., expected state for a class that is in a good state), and the like. An example parameter annotations technology is SAL Annotations in C/C++, and an example of contracts is Code Contracts in .NET/C #. For example, based on emulation of code from application 113 based on a recorded execution 114, the debugger 109 might be able to identify specific instructions in the code of application 113 that did not enforce a contract or violated a contract specified in that code. Similarly, based on the outputs of execution of application 112 (e.g., as recorded in a recorded execution 114, or as generated by a later emulation of that code based on a recorded execution 114), the debugger 109 might be able to identify specific instructions in the code of application 112 that did not enforce a contract or violated a contract specified in that code. As such, the debugger 109 can leverage parameter annotations and/or code contracts to expose potentially costly and/or hard to find bugs.

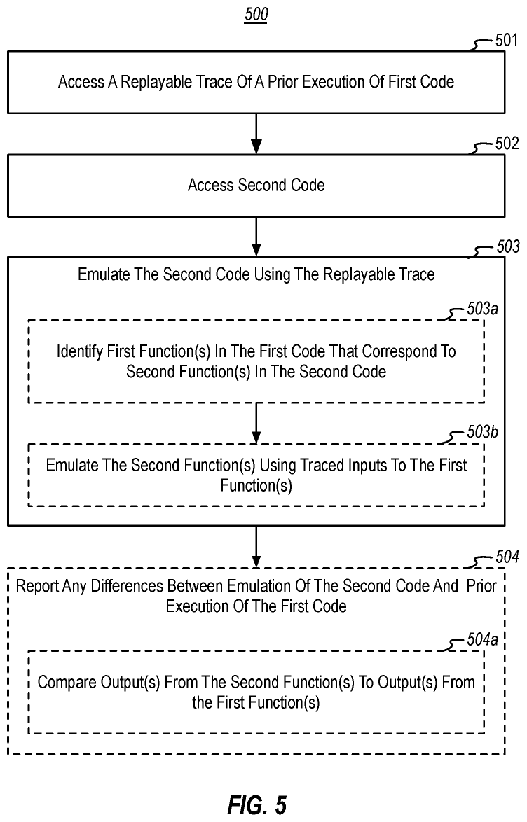

FIG. 5 illustrates a flowchart of an example method 500 for emulating execution of second executable code using trace data gathered during execution of first executable code. Method 500 is now described in connection with FIGS. 1-4.

As shown in FIG. 5, method 500 includes an act 501 of accessing a repayable trace of a prior execution of first code. In some embodiments, act 501 comprises accessing a replayable recorded execution of a prior execution of first executable code, the replayable recorded execution including one or more inputs that were consumed by one or more first executable instructions during the prior execution of the first executable code. For example, the data access component 115 can access a recorded execution 114 of a prior execution of application 112 (e.g., using the trace access sub-component 115a). As shown in FIG. 3, this recorded execution 114 might include at least one data stream 301a that includes a plurality of data packets 302, each of which can include a data inputs portion 304 that records inputs to executable instructions that executed as part of the prior execution of application 112.

Method 500 also includes an act 502 of accessing second code. In some embodiments, act 502 comprises accessing second executable code that is different from the first executable code, execution of second executable code not being recorded in the replayable recorded execution. For example, the data access component 115 can access application 113 (e.g., using the code access sub-component 115b), a prior execution of which is not recorded in the accessed recorded execution 114.

As discussed, application 113 (i.e., the second code) can be functionally related to application 112 (i.e., the first code), such as being compiled from the same source code as application 112, but with different compiler flags, compiler version, or compiler type; and/or being compiled from a modified version of application 112's source code. Thus, in act 502, the first executable code and the second executable code may be compiled from identical source code, but with one or more of (i) different compiler settings or (ii) different compilers. If compiled with different compilers, the different compilers could differ based on least one of (i) compiler version or (ii) compiler type. Additionally, or alternatively, in act 502 the first executable code may be compiled from a first version of source code, while the second executable code is compiled from a second version of the source code that differs from the first version of the source code.

Method 500 also includes an act 503 of emulating the second code using the replayable trace. In some embodiments, act 503 comprises emulating execution of the second executable code using the one or more inputs from the replayable recorded execution. For example, the substitution component 117 can use the emulation component 110 to emulate execution of application 113's code, while using execution state data from recorded execution 114 (i.e., that was obtained during execution of application 112). This emulation may include using the one or more inputs that were consumed by one or more first executable instructions during the prior execution of the first executable code as inputs to one or more second executable instructions of the second executable code during emulation of execution of the one or more second executable instructions.

As discussed, this substitution can be accomplished by the analysis component identifying “functions” in applications 112 and 113 that correspond to each other, based on these functions having the same inputs and outputs. Thus, as shown in FIG. 5, act 503 might include an act 503a of identifying first function(s) in the first code that correspond to second function(s) in the second code, and an act 503b of emulating the second function(s) using traced inputs to the first function(s). In some embodiments, act 503a might comprise identifying a first chunk of first executable instructions in the first executable code (e.g., function 402-a1) that have a same set of inputs (e.g., inputs 403-a) and a same set of outputs (e.g., outputs 404-a) as a second chunk of second executable instructions in the second executable code (e.g., function 402-b1), and act 503b might comprise emulating execution of the second chunk of executable instructions (e.g., function 402-b1) using a particular input (e.g., obtained from recorded execution 114) that was supplied to the first chunk of first executable instructions (e.g., function 402-a1) during the prior execution of the first executable code.

Method 500 might also include an act 504 of reporting any differences between outputs of the second code and outputs of the first code. In some embodiments, act 504 comprises, reporting one or more differences between the emulated execution of the second executable code and the prior execution of the first executable code, or reporting equivalency between the emulated execution of the second executable code and the prior execution of the first executable code. As shown, act 504 might include an act 504a of comparing output(s) from the second function(s) to output(s) from the first function(s). In some embodiments, act 504a comprises comparing a first output produced by the first chunk of executable instructions when using the particular input and a second output produced by the emulated execution of the second chunk of executable instructions when using the particular input to identify one of (i) one or more differences between the emulated execution of the second chunk of executable instructions and a prior execution of the first chunk of executable instructions, or (ii) an equivalency between the emulated execution of the second chunk of executable instructions and the prior execution of the first chunk of executable instructions. For example, the inputs/outputs comparison component 118 might compare the outputs 404-1 of emulation of function 402-b1 when using traced inputs 403-1 with the outputs 404-1 that function 402-a1 produced during its prior execution when using the same inputs 403-1 and the same values for those inputs. The output component 119 can then present any differences between these outputs, or, if there are no differences, indicate that functions 402-a1 and 402-b1 execute equivalently when given identical inputs. As discussed, the outputs 404-1 of function 402-a1 might be obtained from the recorded execution 114, or from an emulation of function 402-a1 by the emulation component 110. Thus, act 504 might include obtaining the first output based on emulating execution of the first chunk of executable instructions using the particular input.

During execution of the code of application 113, the substitution component 117 may need to account for a few different scenarios that arise from transformation of the code in application 113 as compared to the code in application 112. In one example scenario, if application 113 is non-optimized code (while application 112 is optimized), then execution of the code of application 113 may consume more stack space. Because stack pointers are relative, the substitution component 117 may need to account for differences in the base address for the stack pointer. In another example scenario, the code in applications 112 and 113 might access data (e.g., global variables and/or class members) by relative address (e.g., as an offset from a program counter). Since the recorded execution 114 stores this data based on the addresses used by application 112, the code of application 113 might have the wrong offsets for this data. For example, suppose that application 112 accessed particular data based on an offset of 47 bytes from the program counter, while application 113 accesses this same data based on an offset of 148 bytes from the program counter. For correct emulation of application 113, the substitution component 117 needs to account for the differences in this relative access. In some embodiments, the substitution component 117 might perform a static analysis of the code of applications 112 and 113, and translate the offset (as appropriate) in the applications 113's code. In other embodiments, the substitution component 117 might map the code of application 113 into some other memory location (that would normally be inaccessible) in a manner that aligns with the data of application 112. Then, when application 113 makes a relative data access, this mapped code is executed to perform the access, with the relative address being correctly aligned. This could be accomplished for example, by using a memory range breakpoint in application 113's data section, which redirects to the mapped code when triggered. Thus, in method 500, emulating execution of the second chunk of executable instructions might include at least one of translating a pointer offset in the second executable code to align with a pointer offset used by the first executable code, or mapping the second executable code to align with memory offsets used by the first executable code. Other example scenarios include dealing with differences in aliasing behaviors between different compilers, dealing with the order in which different compilers place data in memory, dealing with differences how different compilers lay out classes, etc. In any of these scenarios, symbols can be useful to identify and account for the differences between application 112 and application 113. In embodiments, these differences might also be expressly identified by a compiler.

As an example of using symbols to identify/account for differences between applications 112 and 112, suppose that application 113 includes new code that accesses a global variable. That access will be to a known range of memory addresses, such as the data section of a library. In this case, the emulation component 110 might trap any accesses to this range of memory addresses. The substitution component 117 could use application 113's symbols to determine the particular memory address of the global variable being accessed. The substitution component 117 could also use application 112's symbols to determine the previous memory address for that same global variable in the old code. The substitution component 117 can then cause the emulation component 110 to serve that memory access (read/write) using the old memory address instead of the new one. Thus, symbols have been used to translate the memory layout of globals across two versions of a library. In embodiments, all accesses may need to go through the mapping, because it is possible that between two accesses to the “new” address there is an access to the “old” address (e.g. via a pointer). Notably, this approach can work in either direction—i.e., using the old addresses and mapping accesses to the new address to the old ones via symbols, or using the new address and mapping the accesses to the old address to the new ones via symbols.

In embodiments, the debugging component 109 might include one or more query functions (not shown) that are able to perform queries over recorded execution 114. For example, these query functions might identify memory allocations and deallocations, and determine if there are any allocations that do not have a corresponding deallocation (i.e., a memory leak). In embodiments, these query functions could be extended to perform such queries over the emulated execution of application 113. As such, these query functions could operate as “checkers” to verify whether application 113 has fixed and/or introduced issues, such as memory leaks.

Accordingly, the embodiments described herein leverage historic debugging technologies to emulate execution of non-traced code based on trace data from a recorded execution of related traced code. Thus, the embodiments described herein use a recorded execution of first code to guide emulation of second code that was not traced into this recorded execution. Since the first and second code may have differences, but may be functionally related, emulating non-traced code with a recorded execution of related traced code can be useful to identify compiler bugs (e.g., when different compiler flags, compiler versions, or compiler products result in the production of functionally distinct binaries from the same source code), to determine if source code changes address undesired software behaviors and/or introduce new undesired software behaviors, to enable debugging of non-optimized code based on a trace of optimized code, etc.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method, implemented at a computer system that includes one or more processors and a memory, for emulating execution of second executable code using trace data gathered during execution of first executable code, the method comprising:
accessing a replayable recorded execution of a prior execution of first executable code, the replayable recorded execution including one or more inputs that were consumed by one or more first executable instructions during the prior execution of the first executable code;
accessing second executable code that is different than the first executable code, execution of second executable code not being recorded in the replayable recorded execution;
identifying a mapping between a first sequence of executable instructions in the first executable code and a second sequence of executable instructions in the second executable code, including identifying a mapping between at least one first input that is consumed by the first sequence of executable instructions and at least one second input that is consumed by the second sequence of executable instructions;
emulating execution of the second executable code using the one or more inputs from the replayable recorded execution, including emulating execution of the second sequence of executable instructions based on supplying the second sequence of executable instructions with the at least one first input; and
reporting one or more differences between the emulated execution of the second executable code and the prior execution of the first executable code, or reporting equivalency between the emulated execution of the second executable code and the prior execution of the first executable code.

2. The method of claim 1, wherein emulating execution of the second executable code using the one or more inputs from the replayable recorded execution comprises using the one or more inputs as inputs to one or more second executable instructions of the second executable code during emulation of execution of the one or more second executable instructions.

3. (canceled)

4. The method of claim 1, further comprising comparing a first output produced by the first sequence of executable instructions when using the at least one first input and a second output produced by the emulated execution of the second sequence of executable instructions when using the at least one first input to identify one of (i) one or more differences between the emulated execution of the second sequence of executable instructions and a prior execution of the first sequence of executable instructions, or (ii) an equivalency between the emulated execution of the second sequence of executable instructions and the prior execution of the first sequence of executable instructions.

5. The method of claim 4, further comprising obtaining the first output based on emulating execution of the first sequence of executable instructions using the at least one first input.

6. The method of claim 1, wherein emulating execution of the second executable code comprises at least one of:
translating a pointer offset in the second executable code to align with a pointer offset used by the first executable code; or
mapping the second executable code to align with memory offsets used by the first executable code.

7. The method of claim 1, wherein the first executable code and the second executable code are compiled from identical source code, but with one or more of (i) different compiler settings or (ii) different compilers.

8. The method of claim 7, wherein the different compilers differ based on least one of (i) compiler version or (ii) compiler type.

9. The method of claim 1, wherein the first executable code is compiled from a first version of source code, and the second executable code is compiled from a second version of the source code that differs from the first version of the source code.

10. A computer system, comprising:
one or more processors; and
one or more computer-readable media having stored thereon computer-executable instructions that are executable by the one or more processors to cause the computer system to emulate execution of second executable code using trace data gathered during execution of first executable code, the computer-executable instructions including instructions that are executable by the one or more processors to cause the computer system to perform at least the following:
access a replayable recorded execution of a prior execution of first executable code, the replayable recorded execution including one or more inputs that were consumed by one or more first executable instructions during the prior execution of the first executable code;
access second executable code that is different than the first executable code, execution of second executable code not being recorded in the replayable recorded execution;
identify a mapping between a first sequence of executable instructions in the first executable code and a second sequence of executable instructions in the second executable code, including identifying a mapping between at least one first input that is consumed by the first sequence of executable instructions and at least one second input that is consumed by the second sequence of executable instructions;
emulate execution of the second executable code using the one or more inputs from the replayable recorded execution, including emulating execution of the second sequence of executable instructions based on supplying the second sequence of executable instructions with the at least one first input; and
report one or more differences between the emulated execution of the second executable code and the prior execution of the first executable code, or reporting equivalency between the emulated execution of the second executable code and the prior execution of the first executable code.

11. The computer system of claim 10, wherein emulating execution of the second executable code using the one or more inputs from the replayable recorded execution comprises using the one or more inputs as inputs to one or more second executable instructions of the second executable code during emulation of execution of the one or more second executable instructions.

12. (canceled)

13. The computer system of claim 10, the computer-executable instructions also including instructions that are executable by the one or more processors to cause the computer system to compare a first output produced by the first sequence of executable instructions when using the at least one first input and a second output produced by the emulated execution of the second sequence of executable instructions when using the at least one first input to identify one of (i) one or more differences between the emulated execution of the second sequence of executable instructions and a prior execution of the first sequence of executable instructions, or (ii) an equivalency between the emulated execution of the second sequence of executable instructions and the prior execution of the first sequence of executable instructions.

14. The computer system of claim 13, the computer-executable instructions also including instructions that are executable by the one or more processors to cause the computer system to obtain the first output based on emulating execution of the first sequence of executable instructions using the at least one first input.

15. The computer system of claim 10, wherein emulating execution of the second executable code comprises at least one of:
translating a pointer offset in the second executable code to align with a pointer offset used by the first executable code; or
mapping the second executable code to align with memory offsets used by the first executable code.

16. The computer system of claim 10, wherein the first executable code and the second executable code are compiled from identical source code, but with one or more of (i) different compiler settings or (ii) different compilers.

17. The computer system of claim 16, wherein the different compilers differ based on least one of (i) compiler version or (ii) compiler type.

18. The computer system of claim 10, wherein the first executable code is compiled from a first version of source code, and the second executable code is compiled from a second version of the source code that differs from the first version of the source code.

19. A computer program product comprising one or more computer-readable media having stored thereon computer-executable instructions that are executable by one or more processors to cause a computer system to emulate execution of second executable code using trace data gathered during execution of first executable code, the computer-executable instructions including instructions that are executable by the one or more processors to cause the computer system to perform at least the following:
access a replayable recorded execution of a prior execution of first executable code, the replayable recorded execution including one or more inputs that were consumed by one or more first executable instructions during the prior execution of the first executable code;
access second executable code that is different than the first executable code, execution of second executable code not being recorded in the replayable recorded execution;
identify a mapping between a first sequence of executable instructions in the first executable code and a second sequence of executable instructions in the second executable code, including identifying a mapping between at least one first input that is consumed by the first sequence of executable instructions and at least one second input that is consumed by the second sequence of executable instructions;
emulate execution of the second executable code using the one or more inputs from the replayable recorded execution, including emulating execution of the second sequence of executable instructions based on supplying the second sequence of executable instructions with the at least one first input; and
report one or more differences between the emulated execution of the second executable code and the prior execution of the first executable code, or reporting equivalency between the emulated execution of the second executable code and the prior execution of the first executable code.

20. (canceled)

21. The computer program product of claim 19, the computer-executable instructions also including instructions that are executable by the one or more processors to cause the computer system to:
access the first executable code; and
analyze the first executable code against the second executable code in order to identify the mapping between the first sequence of executable instructions in the first executable code and the second sequence of executable instructions in the second executable code.

22. The method of claim 1, further comprising:
accessing the first executable code; and
analyzing the first executable code against the second executable code in order to identify the mapping between the first sequence of executable instructions in the first executable code and the second sequence of executable instructions in the second executable code.

23. The computer system of claim 10, the computer-executable instructions also including instructions that are executable by the one or more processors to cause the computer system to:
access the first executable code; and
analyze the first executable code against the second executable code in order to identify the mapping between the first sequence of executable instructions in the first executable code and the second sequence of executable instructions in the second executable code.
